(19) United States
(12) Patent Application Publication
(10) Pub. No.: US 2017/0355835 A1
(43) Pub. Date: Dec. 14, 2017

(54) HIGH PERFORMANCE TIRE

(71) Applicant: SUMITOMO RUBBER INDUSTRIES, LTD., Kobe-shi (JP)

(72) Inventor: Hiroki NAKAJIMA, Kobe-shi (JP)

(73) Assignee: SUMITOMO RUBBER INDUSTRIES, LTD., Kobe-shi (JP)

(21) Appl. No.: 15/607,968

(22) Filed: May 30, 2017

(30) Foreign Application Priority Data
Jun. 9, 2016 (JP) 2016-115436

(51) Int. Cl. C08L 9/06; C08L 9/02; C08L 11/00; C08K 5/00; C08L 7/00

(52) U.S. Cl. CPC C08L 9/06; C08K 5/0016; C08L 7/00; C08L 11/00; C08L 9/02

(57) ABSTRACT

A high performance tire includes a tread produced by a process including vulcanizing a rubber composition including a rubber component, a carbon black component, and a plasticizer component. The rubber component includes styrene butadiene rubber in content in the range of 60 to 100 mass % with respect to 100 mass % of the rubber component, the carbon black component includes carbon black having DBP oil absorption of 130 cm³/100 g or more and nitrogen adsorption specific surface area in the range of 100 to 125 m²/g, and the carbon black has content in the range of 100 to 180 parts by mass and the plasticizer component has content in the range of 120 to 250 parts by mass with respect to 100 parts by mass of the rubber component such that the contents of the carbon black and plasticizer components satisfy (the carbon black component content)/(the plasticizer component content)≦0.9.

### CROSS-REFERENCE TO RELATED APPLICATIONS

The present application is based upon and claims the benefit of priority to Japanese Patent Application No. 2016-115436, filed Jun. 9, 2016, the entire contents of which are incorporated herein by reference.

### BACKGROUND OF THE INVENTION

### Field of the Invention

The present invention relates to a high performance tire.

### Description of Background Art

Japanese Patent Laid-Open Publication No. 2004-137463 describes a method of using a high styrene polymer or a high softening point resin. The entire contents of this publication are incorporated herein by reference.

### SUMMARY OF THE INVENTION

According to one aspect of the present invention, a high performance tire includes a tread produced by a process including vulcanizing a rubber composition including a rubber component, a carbon black component, and a plasticizer component. The rubber component includes a styrene butadiene rubber in a content in the range of 60 to 100 mass % with respect to 100 mass % of the rubber component, the carbon black component includes a carbon black having a DBP oil absorption of 130 cm³/100 g or more and a nitrogen adsorption specific surface area in the range of 100 to 125 m²/g, and the carbon black has a content in the range of 100 to 180 parts by mass and the plasticizer component has a content in the range of 120 to 250 parts by mass with respect to 100 parts by mass of the rubber component such that the content of the carbon black component and the content of the plasticizer component satisfy (a content of the carbon black component)/(the content of the plasticizer component)≦0.9.

### DETAILED DESCRIPTION OF THE EMBODIMENTS

Embodiments will now be described.

A high performance tire according to an embodiment of the present invention has a tread manufactured using a rubber composition that includes a rubber component containing a styrene butadiene rubber; a carbon black component containing a carbon black having a DBP oil absorption of 130 cm³/(100 g) or more and a nitrogen adsorption specific surface area of 100-125 m²/g; and a plasticizer component. In 100 mass % of the rubber component, a content of the styrene butadiene rubber is 60-100 mass %. With respect to 100 parts by mass of the rubber component, a content of the carbon black is 100-180 parts by mass, and a content of the plasticizer component is 120-250 parts by mass. The content of the carbon black component and the content of the plasticizer component satisfy the following formula (1):

(the content of the carbon black component)/(the content of the plasticizer component)≦0.9 (1)

By using the rubber composition (tread rubber composition) for a tread, a high performance tire can be realized that allows high grip performance from initial traveling to end of traveling to be achieved while allowing good wear resistance to be ensured, which has been difficult to achieve with a conventional technology.

A tread rubber composition according to an embodiment of the present invention contains styrene butadiene (SBR). For the SBR, for example, an emulsion polymerized styrene butadiene rubber (E-SBR) and a solution polymerized styrene butadiene rubber (S-SBR) can be used, and two or more SBRs may be used in combination.

A styrene content of the SBR is preferably 20 mass % or more, and more preferably 35 mass % or more. When the styrene content is less than 20 mass %, there is a tendency that sufficient grip performance cannot be obtained. Further, the styrene content of the SBR is preferably 60 mass % or less, and more preferably 50 mass % or less. When the styrene content exceeds 60 mass %, there is a tendency that wear resistance decreases and temperature dependency increases and good grip performance on a high temperature road surface cannot be achieved.

The styrene content of the SBR is calculated based on H1-NMR measurement.

A vinyl content in a butadiene component of the SBR is preferably 20 mass % or more, and more preferably 35 mass % or more. When the vinyl content is less than 20 mass %, there is a tendency that sufficient grip performance cannot be obtained. Further, the vinyl content in the butadiene component of the SBR is preferably 60 mass % or less, and more preferably 50 mass % or less. When the vinyl content exceeds 60 mass %, there is a tendency that wear resistance decreases.

The vinyl content in the butadiene component of the SBR is measured using infrared absorption spectroscopy.

A content of the SBR in 100 mass % of the rubber component may be 60 mass % or more. However, from a point of view that the effect according to an embodiment of the present invention can be satisfactorily obtained, the content of the SBR is preferably 90 mass % or more, and more preferably 100 mass %.

A tread rubber composition according to an embodiment of the present invention may contain rubber components other than the SBR, such as a natural rubber (NR), an isoprene rubber (IR), a butadiene rubber (BR), a styrene isoprene butadiene rubber (SIBR), an ethylene propylene diene rubber (EPDM), a chloroprene rubber (CR), an acrylonitrile butadiene rubber (NBR), and a butyl rubber (IIR).

A tread rubber composition according to an embodiment of the present invention contains, as a reinforcing filler, the carbon black component that contains the carbon black having a DBP oil absorption of 130 cm³/(100 g) or more and a nitrogen adsorption specific surface area of 100-125 m²/g.

The carbon black can be manufactured using a method of Examples to be described later.

The DBP oil absorption (OAN) of the carbon black is 130 cm³/(100 g) or more, and preferably 135 cm³/(100 g) or more. When the DBP oil absorption of the carbon black is less than 130 cm³/(100 g), there is a risk that sufficient wear resistance cannot be obtained. Further, the DBP oil absorption of the carbon black is preferably 200 cm³/(100 g) or less, more preferably 180 cm³/(100 g) or less, and even more preferably 160 cm³/(100 g) or less. When the DBP oil absorption of the carbon black exceeds 200 cm³/(100 g), there is a risk that grip performance may decrease.

The DBP oil absorption of the carbon black is measured according to JIS K 6217-4.

The nitrogen adsorption specific surface area (N₂SA) of the carbon black is 100 m²/g or more, and preferably 110 m²/g or more. When the N₂SA of the carbon black is less than 100 m²/g, there is a risk that sufficient grip performance cannot be obtained. Further, the N₂SA of the carbon black is 125 m²/g or less, and preferably 122 m²/g or less. When the N₂SA of the carbon black exceeds 125 m²/g, there is a risk that wear resistance may decrease.

The N₂SA of the carbon black is obtained according to JIS K 6217-2.

A content of the carbon black with respect to 100 parts by mass of the rubber component is 100 parts by mass or more, and preferably 120 parts by mass or more. When the content of the carbon black is less than 100 parts by mass, there is a risk that sufficient wear resistance cannot be obtained. Further, the content of the carbon black with respect to 100 parts by mass of the rubber component is 180 parts by mass or less, preferably 170 parts by mass or less, and more preferably 150 parts by mass or less. When the content of the carbon black exceeds 180 parts by mass, there is a risk that sufficient initial grip performance cannot be obtained.

A tread rubber composition according to an embodiment of the present invention may contain, as the carbon black component, a carbon black other than the above-described carbon black.

From a point of view that the effect according to an embodiment of the present invention can be satisfactorily obtained, the content of the carbon black component (total content of the above-described carbon black and other carbon blacks) with respect to 100 parts by mass of the rubber component is preferably 100 parts by mass or more, and more preferably 120 parts by mass or more, and preferably 180 parts by mass or less, more preferably 170 parts by mass or less, and even more preferably 150 parts by mass or less.

A tread rubber composition according to an embodiment of the present invention may contain reinforcing fillers other than the carbon black component such as silica, calcium carbonate, alumina, clay, and talc, which are reinforcing fillers used in tire rubber compositions.

A tread rubber composition according to an embodiment of the present invention contains the plasticizer component. As the plasticizer component, a tackifying resin and a liquid diene-based polymer can be suitably used.

As the tackifying resin, a resin having a structural unit based on at least one selected from a group of phenol, coumaron, indene, terpene, acrylic acid ester, methacrylic acid ester, styrene, t-butylphenol and acetylene can be suitably used. These resins may each be independently used, or two or more of these resins may be used in combination. Among these resins, a resin having a structural unit based on at least one selected from a group of terpene, styrene, t-butylphenol and acetylene is preferable.

Further, specific examples of the resins include a phenol resin, a coumarone-indene resin, a terpene resin, a copolymer of terpene and styrene, an acrylic resin, a methacrylic resin, a copolymer of t-butylphenol and acetylene, and the like. A copolymer of terpene and styrene, and a copolymer of t-butylphenol and acetylene are preferable.

A softening point of the tackifying resin is preferably 100° C. or higher, more preferably 110° C. or higher, and even more preferably 140° C. or higher. When the softening point of the tackifying resin is lower than 100° C., there is a risk that sufficient grip performance cannot be obtained. Further, the softening point of the tackifying resin is preferably 180° C. or lower, and more preferably 170° C. or lower. When the softening point of the tackifying resin exceeds 180° C., there is a risk that wear resistance may decrease.

The softening point of the tackifying resin is a temperature at which a ball falls in measurement of a softening point defined in JIS K 6220-1 using a ring and ball softening point measuring apparatus.

A content of the tackifying resin with respect to 100 parts by mass of the rubber component is preferably 20 parts by mass or more, and more preferably 30 parts by mass or more. When the content of the tackifying resin is less than 20 parts by mass, there is a risk that sufficient grip performance cannot be obtained. Further, the content of the tackifying resin with respect to 100 parts by mass of the rubber component is preferably 90 parts by mass or less, and more preferably 70 parts by mass or less. When the content of the tackifying resin exceeds 90 parts by mass, there is a risk that sufficient initial grip performance and wear resistance cannot be obtained.

The liquid diene-based polymer is a diene polymer in a liquid state at a normal temperature (25° C.). Examples of the liquid diene-based polymer include a liquid styrene butadiene copolymer (liquid SBR), a liquid butadiene polymer (liquid BR), a liquid isoprene polymer (liquid IR), a liquid styrene isoprene copolymer (liquid SIR), and the like. These liquid diene-based polymers may each be independently used, or two or more of these liquid diene-based polymers may be used in combination. Among these liquid diene-based polymers, from a point of view of grip performance and wear resistance, the liquid SBR is preferable.

A weight-average molecular weight (Mw) of the liquid diene-based polymer based on polystyrene conversion measured using gel permeation chromatography (GPC) is preferably 1.0×10³ or more and 2.0×10⁵ or less, and more preferably 3.0×10³ or more and 1.5×10⁴ or less. When the weight-average molecular weight (Mw) is less than 1.0×10³, there is a risk that sufficient wear resistance cannot be obtained, and when the weight-average molecular weight (Mw) exceeds 2.0×10⁵, there is a risk that viscosity of a polymerization solution may become too high and productivity may decrease.

The weight-average molecular weight (Mw) of the liquid diene-based polymer is a polystyrene conversion value measured using gel permeation chromatography (GPC).

A content of the liquid diene-based polymer with respect to 100 parts by mass of the rubber component is preferably 30 parts by mass or more, and more preferably 40 parts by mass or more. When the content of the liquid diene-based polymer is less than 30 parts by mass, there is a risk that sufficient grip performance cannot be obtained. Further, the content of the liquid diene-based polymer with respect to 100 parts by mass of the rubber component is preferably 150 parts by mass or less, more preferably 120 parts by mass or less, and even more preferably 100 parts by mass or less. When the content of the liquid diene-based polymer exceeds 150 parts by mass, there is a risk that sufficient wear resistance cannot be obtained.

A tread rubber composition according to an embodiment of the present invention may contain plasticizer components other than the tackifying resin and the liquid diene-based polymer, such as oil and the like, which are plasticizers (softening agents) used in tire rubber compositions.

As the oil, mineral oil such as aromatic oil, process oil, paraffin oil or the like can be used.

When oil is used as a plasticizer component, from a point of view that the effect according to an embodiment of the present invention can be satisfactorily obtained, a content of the oil is preferably 20 parts by mass or more and 100 parts by mass or less, and more preferably 40 parts by mass or more and 80 parts by mass or less.

A content of the plasticizer component with respect to 100 parts by mass of the rubber component is 120 parts by mass or more, and preferably 130 parts by mass or more. When the content of the plasticizer component is less than 120 parts by mass, there is a risk that sufficient grip performance cannot be obtained. Further, the content of the plasticizer component with respect to 100 parts by mass of the rubber component is 250 parts by mass or less, and preferably 200 parts by mass or more. When the content of the plasticizer component exceeds 250 parts by mass, there is a risk that sufficient wear resistance cannot be obtained.

In a tread rubber composition according to an embodiment of the present invention, the content of the carbon black component and the content of the plasticizer component satisfy the following formula (1):

(the content of the carbon black component)/(the content of the plasticizer component)≦0.9 (1)

When (the content of the carbon black component)/(the content of the plasticizer component) exceeds 0.9, there is a risk that sufficient grip performance cannot be obtained. A lower limit of the formula (1) is not particularly limited, but is preferably 0.6.

In a tread rubber composition according to an embodiment of the present invention, in addition to the above-described components, compounding agents used in the tire industry, such as a vulcanization accelerator, a vulcanization agent, zinc oxide, wax, and an anti-aging agent may be appropriately blended.

Examples of vulcanization accelerators include sulfenamide-based, thiazole-based, thiuram-based, guanidine-based, and dithiocarbamate-based vulcanization accelerators and the like. These vulcanization accelerators may each be independently used, or two or more of these vulcanization accelerators may be used in combination. Among these vulcanization accelerators, the sulfenamide-based and dithiocarbamate-based vulcanization accelerators are preferable.

Examples of sulphenamide-based vulcanization accelerators include N-tert-butyl-2-benzothiazolylsulfenamide (NS), N-cyclohexyl-2-benzothiazolylsulfenamide (CZ), N-Oxydiethylene-2-benzothiazolylsulfenamide (MSA), and the like. These sulphenamide-based vulcanization accelerators may each be independently used, or two or more of these sulphenamide-based vulcanization accelerators may be used in combination. Among these sulphenamide-based vulcanization accelerators, NS is preferable.

Examples of dithiocarbamate-based vulcanization accelerators include zinc dibenzyldithiocarbamate (ZTC), zinc dimethyldithiocarbamate (PZ), zinc N-pentamethylenedithiocarbamate (ZP), sodium dibutyldithiocarbamate (TP), and the like. These dithiocarbamate-based vulcanization accelerators may each be independently used, or two or more of these dithiocarbamate-based vulcanization accelerators may be used in combination. Among these dithiocarbamate-based vulcanization accelerators, ZTC is preferable.

A content of the vulcanization accelerator with respect to 100 parts by mass of the rubber component is preferably 1 part by mass or more and 15 parts by mass or less, and more preferably 3 parts by mass or more and 10 parts by mass or less. When the content of the vulcanization accelerator is less than 1 part by mass, there is a tendency that a sufficient vulcanization speed cannot be obtained and good grip performance and wear resistance cannot to be obtained. When the content of the vulcanization accelerator exceeds 15 parts by mass, there is a risk that blooming may occur, and grip performance and wear resistance may decrease.

As a vulcanization agent, sulfur is preferable.

A content of the sulfur with respect to 100 parts by mass of the rubber component is preferably 0.5 parts by mass −3 parts by mass. When the content of the sulfur is less than 0.5 parts by mass, there is a risk that a good vulcanization reaction cannot be obtained and wear resistance may decrease. When the content of the sulfur exceeds 3 parts by mass, there is a risk that blooming may occur and sufficient grip performance and wear resistance cannot be obtained.

Zinc oxide is not particularly limited, and zinc oxide used in the rubber fields such as tires can be used. Fine particle zinc oxide having an average particle size of 200 nm or less (preferably 100 nm or less) can be suitably used. A lower limit for the average particle size of the fine particle zinc oxide is not particularly limited, but is preferably 20 nm or more, and more preferably 30 nm or more.

The average particle size of the zinc oxide is an average particle size (average primary particle size) converted from a specific surface area measured using a BET method based on nitrogen adsorption.

From a point of view that the effect according to an embodiment of the present invention can be satisfactorily obtained, a content of the zinc oxide with respect to 100 parts by mass of the rubber component is preferably 0.5 parts by mass or more and 10 parts by mass or less, and more preferably 1 part by mass or more and 5 parts by mass or less.

A high performance tire according to an embodiment of the present invention is manufactured using a normal method using the above-described rubber composition.

That is, the rubber composition containing the above-described components is extruded in accordance with a shape of a tread at an unvulcanized stage, and is molded together with other tire members on a tire molding machine using a normal method. Thereby, an unvulcanized tire is formed. By heating and pressing the unvulcanized tire in a vulcanizer, a high performance tire according to an embodiment of the present invention is obtained.

A high performance tire according to an embodiment of the present invention can be suitably used as a high performance dry tire.

The term “high performance tire” in the present specification refers to a tire that is particularly excellent in grip performance, and is a concept that also includes a tire for competition to be used in a competition vehicle. Further, in the present specification, the term “dry tire” refers to a tire that is particularly excellent in dry grip performance.

### EXAMPLES

Based on Examples, the present invention is described in detail. However, the present invention is not limited to these Examples.

In the following, various chemicals in examples and comparative examples are collectively described.

SBR: Tafuden 4850 (styrene content: 40 mass %; vinyl content in butadiene component: 41 mass %, containing 50 parts by mass of an oil component with respect to 100 parts by mass of a solid rubber component) manufactured by Asahi Kasei Corporation

Carbon black: N220 (OAN: 114 cm³/(100 g); N₂SA: 114 m²/g) manufactured by Cabot Japan Co., Ltd.

Prototype carbon black: Manufacturing Example 1 described below

Oil: Diana Process AH-24 manufactured by Idemitsu Kosan Co., Ltd.

Liquid diene-based polymer: L-SBR-820 (liquid SBR; Mw: 10000) manufactured by Kuraray Co., Ltd.

Tackifying resin 1: Koresin (copolymer of p-t-butylphenol and acetylene; softening point: 160° C.) manufactured by BASF

Tackifying resin 2: YS Resin TO125 (copolymer of terpene and styrene; softening point: 125° C.) manufactured by Yasuhara Chemical Co., Ltd.

Wax: Sannock N manufactured by Ouchi Shinko Chemical Industry Co., Ltd.

Anti-aging agent 1: Nocrac 6C manufactured by Ouchi Shinko Chemical Industry Co., Ltd.

Anti-aging agent 2: Nocrac RD manufactured by Ouchi Shinko Chemical Industry Co., Ltd.

Stearic acid: Stearic Acid “Camellia” manufactured by NOF Corporation

Zinc oxide: Jincoc Super F-1 (average particle size: 100 nm) manufactured by Hakusuitech Co., Ltd.

Sulfur: Powdered sulfur manufactured by Tsurumi Chemical Co., Ltd.

Vulcanization accelerator 1: Nocceler NS (N-tert-butyl-2-benzothiazolyl sulfenamide) manufactured by Ouchi Shinko Chemical Industry Co., Ltd.

Vulcanization accelerator 2: Nocceler ZTC (zinc dibenzyldithiocarbamate) manufactured by Ouchi Shinko Chemical Industrial Co., Ltd.

### Manufacturing Example 1

Prototype carbon black is manufactured based on conditions shown in Table 1 using natural gas as fuel and tall oil as a raw material using carbon black manufacturing equipment in which a combustion zone (having an inner diameter of 500 mm and a length of 1750 mm equipped with an air introduction duct and a combustion burner), a raw material introduction zone (including a narrow diameter part having an inner diameter of 55 mm and a length of 700 mm provided with a raw material nozzle penetrating from surrounding), and a rear reaction zone (having an inner diameter of 200 mm and a length of 2700 mm equipped with a quenching device) are sequentially joined. DBP oil absorption and N₂SA of the obtained prototype carbon black are shown in Table 1.

TABLE 1

| | | | Manufacturing |
|---|---|---|---|
| | | | Example |
| | | | 1 |
| Operation | Combustion air amount | Nm³/hr | 5000 |
| conditions | Combustion temperature | ° C. | 600 |
| | Raw material oil amount | kg/hr | 700 |
| Raw material | Tall oil | | 100 |
| oil blending | | | |
| (parts by mass) | | | |
| Characteristics | DBP oil absorption | cm³/(100 g) | 140 |
| | N₂SA | m²/g | 120 |

### EXAMPLES AND COMPARATIVE EXAMPLES

According to formulations shown in Table 2, the materials are kneaded using a 1.7 L Banbury (manufactured by Kobe Steel Co., Ltd.). The obtained unvulcanized rubber composition is confirmed to be free from melt residues of compounding agents based on Mooney viscosity and a cross-sectional state when the unvulcanized rubber composition is formed into a sheet having a width of 20 cm and a thickness of 1 cm. Thereafter, the unvulcanized rubber composition is molded into a tread shape, and is bonded together with other tire members on a tire molding machine, and is vulcanized at 150° C. for 30 minutes, and a test tire (tire size: 215/45R17) is obtained.

The following evaluations are performed with respect to the obtained test tires. Evaluation results are shown in Table 2.

### Initial Grip Performance

The test tire is mounted on a domestically manufactured FR vehicle having a displacement of 2000 cc, and the vehicle is driven for 10 laps on a test course having a dry asphalt road surface. In this case, a test driver evaluated stability of control during steering in a second lap and the evaluation result is expressed as an index number with Comparative Example 1 as 100 (initial grip performance index number). A larger index number indicates a better initial grip performance on a dry road surface.

### Grip Performance During Traveling

The test tire is mounted on a domestically manufactured FR vehicle having a displacement of 2000 cc, and the vehicle is driven for 10 laps on a test course having a dry asphalt road surface. In this case, the test driver evaluates by comparison the stability of control during steering in a best lap and in a final lap, and the evaluation result is expressed as an index number with Comparative Example 1 as 100 (grip performance index number during traveling). A larger index number indicates a smaller decrease in grip performance during traveling and more stable grip performance during traveling on a dry road surface.

### Wear Resistance

The test tire is mounted on a domestically manufactured FR vehicle having a displacement of 2000 cc, and the vehicle is driven on a test course having a dry asphalt road surface. In this case, a remaining groove amount of the tread is measured (15 mm when new), and the result is expressed as an index number with a remaining groove amount of Comparative Example 1 as 100 (wear resistance index number). A larger index number indicates a higher wear resistance.

TABLE 2

| | | Comparative Example | | | | | | Example | | | | | |
|---|---|---|---|---|---|---|---|---|---|---|---|---|---|
| | | 1 | 2 | 3 | 4 | 5 | 6 | 1 | 2 | 3 | 4 | 5 | 6 |
| Composition | SBP | 150 | 150 | 150 | 150 | 150 | 150 | 150 | 150 | 150 | 150 | 150 | 150 |
| (parts by mass) | (oil component: | | | | | | | | | | | | |
| | 50 parts by mass) | | | | | | | | | | | | |
| | Carbon black | 120 | 120 | 120 | 120 | 120 | — | — | — | — | — | — | — |
| | Prototype carbon | — | — | — | — | — | 120 | 120 | 120 | 120 | 120 | 140 | 120 |
| | black | | | | | | | | | | | | |
| | Oil | 70 | 90 | 50 | — | — | 70 | — | — | — | — | — | 90 |
| | Liquid diene- | — | — | — | 50 | 50 | — | 50 | 50 | 70 | 50 | 70 | — |
| | based polymer | | | | | | | | | | | | |
| | Tackifying resin 1 | — | — | 40 | 40 | 20 | — | 40 | 20 | 20 | 30 | 30 | — |
| | Tackifying resin 2 | — | — | — | — | 20 | — | — | 20 | 20 | 30 | 30 | — |
| | Wax | 2 | 2 | 2 | 2 | 2 | 2 | 2 | 2 | 2 | 2 | 2 | 2 |
| | Anti-aging agent 1 | 1.5 | 1.5 | 1.5 | 1.5 | 1.5 | 1.5 | 1.5 | 1.5 | 1.5 | 1.5 | 1.5 | 1.5 |
| | Anti-aging agent 2 | 2 | 2 | 2 | 2 | 2 | 2 | 2 | 2 | 2 | 2 | 2 | 2 |
| | Stearic acid | 2 | 2 | 2 | 2 | 2 | 2 | 2 | 2 | 2 | 2 | 2 | 2 |
| | Zinc oxide | 3 | 3 | 3 | 3 | 3 | 3 | 3 | 3 | 3 | 3 | 3 | 3 |
| | Sulfur | 1.5 | 1.5 | 1.5 | 1.5 | 1.5 | 1.5 | 1.5 | 1.5 | 1.5 | 1.5 | 1.5 | 1.5 |
| | Vulcanization | 4 | 4 | 4 | 4 | 4 | 4 | 4 | 4 | 4 | 4 | 4 | 4 |
| | accelerator 1 | | | | | | | | | | | | |
| | Vulcanization | 1 | 1 | 1 | 1 | 1 | 1 | 1 | 1 | 1 | 1 | 1 | 1 |
| | accelerator 2 | | | | | | | | | | | | |
| Carbon black content (A) | | 120 | 120 | 120 | 120 | 120 | 120 | 120 | 120 | 120 | 120 | 140 | 120 |
| Plasticizer content (B) | | 120 | 140 | 140 | 140 | 140 | 120 | 140 | 140 | 160 | 160 | 180 | 140 |
| (A)/(B) | | 1 | 0.85 | 0.85 | 0.85 | 0.85 | 1 | 0.85 | 0.85 | 0.75 | 0.75 | 0.78 | 0.85 |
| Evaluation | Initial grip | 100 | 135 | 110 | 120 | 125 | 100 | 120 | 135 | 163 | 150 | 162 | 115 |
| | performance | | | | | | | | | | | | |
| | index number | | | | | | | | | | | | |
| | Grip performance | 100 | 88 | 130 | 132 | 120 | 80 | 140 | 132 | 133 | 150 | 152 | 120 |
| | index number | | | | | | | | | | | | |
| | during traveling | | | | | | | | | | | | |
| | Wear resistance | 100 | 88 | 60 | 65 | 68 | 140 | 120 | 125 | 115 | 112 | 119 | 130 |
| | index number | | | | | | | | | | | | |

As shown in Table 2, as compared to Comparative Example 1, the initial grip performance, the grip performance during traveling, and the wear resistance are all improved in Examples in which a tread is manufactured using a rubber composition that contains predetermined amounts of a SBR, a carbon black (prototype carbon black) having a DBP oil absorption of 130 cm³/(100 g) or more and a nitrogen adsorption specific surface area of 100-125 m²/g, and a plasticizer component, and in which a content of the carbon black component and a content of the plasticizer component satisfy the formula (1).

For a tread rubber composition of a high performance tire, both high grip performance of initial traveling (initial grip performance) and stable grip performance during traveling are required. In order to ensure these performances, various efforts have been made in the past.

As a method for improving initial grip performance, an amount of a plasticizer may be increased. On the other hand, as a method for obtaining stable grip performance during traveling, a method of using a high styrene polymer or a high softening point resin is studied in Japanese Patent Laid-Open Publication No. 2004-137463.

However, when an amount of a plasticizer is increased, although initial grip performance is improved, wear resistance and grip performance during traveling tend to decrease. Further, when a high styrene polymer or a high softening point resin is used, although stable grip performance during traveling can be obtained, initial grip performance and wear resistance tend to decrease. Thus, using the conventional methods, it is difficult to improve initial grip performance, grip performance during traveling and wear resistance in a well-balanced manner.

A high performance tire according to an embodiment of the present invention improves initial grip performance, grip performance during traveling and wear resistance in a well-balanced manner.

A high performance tire according to an embodiment of the present invention has a tread manufactured using a rubber composition that includes a rubber component containing a styrene butadiene rubber; a carbon black component containing a carbon black having a DBP oil absorption of 130 cm³/(100 g) or more and a nitrogen adsorption specific surface area of 100-125 m²/g; and a plasticizer component. In 100 mass % of the rubber component, a content of the styrene butadiene rubber is 60-100 mass %. With respect to 100 parts by mass of the rubber component, a content of the carbon black is 100-180 parts by mass, and a content of the plasticizer component is 120-250 parts by mass. The content of the carbon black component and the content of the plasticizer component satisfy the following formula (1):

(the content of the carbon black component)/(the content of the plasticizer component)≦0.9 (1)

It is preferable that the plasticizer component include a tackifying resin and a liquid diene-based polymer, and, with respect to 100 parts by mass of the rubber component, a content of the tackifying resin be 20-90 parts by mass, and a content of the liquid diene-based polymer be 30-150 parts by mass.

It is preferable that the tackifying resin have a softening point of 100-180° C. and be a resin having a structural unit based on at least one selected from a group of phenol, coumaron, indene, terpene, acrylic acid ester, methacrylic acid ester, styrene, t-butylphenol, and acetylene.

A tread according to an embodiment of the present invention is manufactured using the rubber composition that contains the predetermined amounts of the styrene butadiene rubber, the carbon black having a DBP oil absorption of 130 cm³/(100 g) or more and a nitrogen adsorption specific surface area of 100-125 m²/g, and the plasticizer component, and in which the content of the carbon black component and the content of the plasticizer component satisfy the formula (1). Therefore, a high performance tire that allows initial grip performance, grip performance during traveling, and wear resistance to be improved in a well-balanced manner can be obtained.

Obviously, numerous modifications and variations of the present invention are possible in light of the above teachings. It is therefore to be understood that within the scope of the appended claims, the invention may be practiced otherwise than as specifically described herein.

What is claimed is:

1. A high performance tire, comprising:
a tread produced by a process comprising vulcanizing a rubber composition comprising a rubber component, a carbon black component, and a plasticizer component,
wherein the rubber component comprises a styrene butadiene rubber in a content in a range of 60 to 100 mass % with respect to 100 mass % of the rubber component, the carbon black component comprises a carbon black having a DBP oil absorption of 130 cm³/100 g or more and a nitrogen adsorption specific surface area in a range of 100 to 125 m²/g, and the carbon black has a content in a range of 100 to 180 parts by mass and the plasticizer component has a content in a range of 120 to 250 parts by mass with respect to 100 parts by mass of the rubber component such that the content of the carbon black component and the content of the plasticizer component satisfy (carbon black component content)/(plasticizer component content)≦0.9.

2. The high performance tire according to claim 1, wherein the plasticizer component includes a tackifying resin and a liquid diene-based polymer such that with respect to 100 parts by mass of the rubber component, the tackifying resin has a content in a range of 20 to 90 parts by mass and the liquid diene-based polymer has a content in a range of 30 to 150 parts by mass.

3. The high performance tire according to claim 2, wherein the tackifying resin has a softening point in a range of 100 to 180° C. and comprises a resin having a structural unit based on at least one selected from the group consisting of phenol, coumaron, indene, terpene, acrylic acid ester, methacrylic acid ester, styrene, t-butylphenol, and acetylene.

4. The high performance tire according to claim 1, wherein the carbon black of the carbon black component has the DBP oil absorption in a range of 130 cm³/100 g to 200 cm³/100 g.

5. The high performance tire according to claim 1, wherein the content of the carbon black is in a range of 120 to 170 parts by mass and the content of the plasticizer component is in a range of 130 to 200 parts by mass with respect to 100 parts by mass of the rubber component such that the content of the carbon black component and the content of the plasticizer component satisfy (carbon black component content)/(plasticizer component content)≦0.9.

6. The high performance tire according to claim 5, wherein the plasticizer component includes a tackifying resin and a liquid diene-based polymer such that with respect to 100 parts by mass of the rubber component, the tackifying resin has a content in a range of 20 to 90 parts by mass and the liquid diene-based polymer has a content in a range of 30 to 150 parts by mass.

7. The high performance tire according to claim 6, wherein the tackifying resin has a softening point in a range of 100 to 180° C. and comprises a resin having a structural unit based on at least one selected from the group consisting of phenol, coumaron, indene, terpene, acrylic acid ester, methacrylic acid ester, styrene, t-butylphenol, and acetylene.

8. The high performance tire according to claim 5, wherein the carbon black of the carbon black component has the DBP oil absorption in a range of 130 cm³/100 g to 200 cm³/100 g.

9. The high performance tire according to claim 1, wherein the content of the carbon black is in a range of 120 to 150 parts by mass and the content of the plasticizer component is in a range of 130 to 200 parts by mass with respect to 100 parts by mass of the rubber component such that the content of the carbon black component and the content of the plasticizer component satisfy (carbon black component content)/(plasticizer component content)≦0.9.

10. The high performance tire according to claim 9, wherein the plasticizer component includes a tackifying resin and a liquid diene-based polymer such that with respect to 100 parts by mass of the rubber component, the tackifying resin has a content in a range of 20 to 90 parts by mass and the liquid diene-based polymer has a content in a range of 30 to 150 parts by mass.

11. The high performance tire according to claim 10, wherein the tackifying resin has a softening point in a range of 100 to 180° C. and comprises a resin having a structural unit based on at least one selected from the group consisting of phenol, coumaron, indene, terpene, acrylic acid ester, methacrylic acid ester, styrene, t-butylphenol, and acetylene.

12. The high performance tire according to claim 9, wherein the carbon black of the carbon black component has the DBP oil absorption in a range of 130 cm³/100 g to 200 cm³/100 g.

13. The high performance tire according to claim 2, wherein the tackifying resin has a softening point in a range of 100 to 180° C. and comprises a resin having a structural unit based on at least one selected from the group consisting of terpene, styrene, t-butylphenol, and acetylene.

14. The high performance tire according to claim 2, wherein the tackifying resin has a softening point in a range of 100 to 180° C. and comprises at least one resin selected from the group consisting of a phenol resin, a coumarone-indene resin, a terpene resin, a copolymer of terpene and styrene, an acrylic resin, a methacrylic resin, and a copolymer of t-butylphenol and acetylene.

15. The high performance tire according to claim 2, wherein the tackifying resin has a softening point in a range of 100 to 180° C. and comprises at least one resin selected from the group consisting of a copolymer of terpene and styrene and a copolymer of t-butylphenol and acetylene.

16. The high performance tire according to claim 1, wherein the plasticizer component includes a tackifying resin and a liquid diene-based polymer such that with respect to 100 parts by mass of the rubber component, the tackifying resin has a content in a range of 30 to 70 parts by mass and the liquid diene-based polymer has a content in a range of 40 to 120 parts by mass.

17. The high performance tire according to claim 16, wherein the tackifying resin has a softening point in a range of 100 to 180° C. and comprises a resin having a structural unit based on at least one selected from the group consisting of phenol, coumaron, indene, terpene, acrylic acid ester, methacrylic acid ester, styrene, t-butylphenol, and acetylene.

18. The high performance tire according to claim 16, wherein the carbon black of the carbon black component has the DBP oil absorption in a range of 130 cm³/100 g to 200 cm³/100 g.

19. The high performance tire according to claim 16, wherein the content of the carbon black is in a range of 120 to 170 parts by mass and the content of the plasticizer component is in a range of 130 to 200 parts by mass with respect to 100 parts by mass of the rubber component such that the content of the carbon black component and the content of the plasticizer component satisfy (carbon black component content)/(plasticizer component content)≦0.9.

20. The high performance tire according to claim 16, wherein the tackifying resin has a softening point in a range of 100 to 180° C. and comprises at least one resin selected from the group consisting of a phenol resin, a coumarone-indene resin, a terpene resin, a copolymer of terpene and styrene, an acrylic resin, a methacrylic resin, and a copolymer of t-butylphenol and acetylene.
